(19) United States
(12) Patent Application Publication
(10) Pub. No.: US 2003/0121012 A1
(43) Pub. Date: Jun. 26, 2003

(54) Crosstalk verifying device

(75) Inventors: Keiko Mishima, Tokyo (JP); Yoshifumi Sasaki, Tokyo (JP); Tomoo Ishida, Tokyo (JP); Takahiro Oda, Tokyo (JP)

Correspondence Address: MCDERMOTT, WILL & EMERY, 600 13th Street, N.W., WASHINGTON, DC, 20005-3096, US

(73) Assignee: Mitsubishi Denki Kabushiki Kaisha

(21) Appl. No.: 10/172,007

(22) Filed: Jun. 17, 2002

(30) Foreign Application Priority Data
Dec. 21, 2001 (JP) 2001-389179

(51) Int. Cl. G06F 17/50

(52) U.S. Cl. 716/5; 716/4

(57) ABSTRACT

A node and coupling capacity selecting portion 4 extracts nodes (NDI) which simultaneously change from a net list (NTL) of a circuit diagram based on an input pattern (IP) and extracts a coupling capacity (CCI) not less than a designated value, and determines a node whose coupling capacity should be considered from the extraction result, and creats and holds information (ND/CC) of the judged nodes and the coupling capacities thereof. Then, simulation of the selected nodes including the coupling capacities thereof is conducted so that the result of the simulation is displayed in a waveform to thereby enable an efficient and highly precise crosstalk verification.

### BACKGROUND OF THE INVENTION

1. Field of the Invention

The present invention relates to a crosstalk verifying device for verifying a crosstalk influence of a coupling capacity parasitic in a designed circuit on a circuit operation.

2. Description of the Prior Art

When there occurs a crosstalk at a location where wirings are located adjacent to each other on a layout of such as an LSI or the like semiconductor circuit, a signal delay on one wiring of the adjacent wirings is affected by a signal transition on the other wiring. That is, a speed of a signal transition in one wiring is increased when the transition of the signal on the other wiring is effected in the same direction. On the other hand, when the transition of the signal is effected in the opposite direction, the speed of the transition is decreased. In this manner, the signal delay in one wiring is affected in accordance with the signal transition of the other wiring, which leads to a noise, an operation failure and the like. Consequently, when a semiconductor circuit such as an LSI or the like is designed, it is desired that the crosstalk verification is conducted in a high precision for verifying the crosstalk influence of a coupling capacity parasitic in the designed circuit on a circuit operation.

FIG. 16 shows an entire configuration of a conventional crosstalk verifying device. In FIG. 16, reference numeral 101 denotes a circuit diagram creating portion, numeral 102 denotes a net list creating portion, numeral 103 denotes a layout crating portion, numeral 104 denotes a coupling capacity extracting portion, numeral 105 denotes a crosstalk analyzing portion, and numeral 106 denotes a waveform display portion. The circuit diagram creating portion 101 arranges wires and connects circuit symbols such as a transistor, a resistor, a capacitor or the like to prepare a circuit diagram. The network list creating portion 102 creates a net list from the circuit diagram data while the layout creating portion 103 creates layout data on the basis of the circuit diagram. The coupling capacity extracting portion 104 extracts coupling capacities not less than a designated value from the layout data and also extracts coupling capacities of nodes selected by a circuit designer. The crosstalk analyzing portion 105 conducts a simulation operation using information of the net list created by the net list creating portion 102, an input pattern and the coupling capacities extracted by the coupling capacity extracting portion 104, and generates waveform data. The waveform display portion 106 displays the simulation result of the waveform data.

Next, an operation of the conventional configuration will be explained. In the first step, the circuit diagram is prepared by the circuit diagram creating portion 101. On the basis of the prepared circuit diagram, the layout creating portion 103 creates a layout. Meanwhile, the net list creating portion 102 creates a net list of a circuit to be subject to a crosstalk analysis from the circuit diagram data. Next, the coupling capacity extracting portion 104 extracts the coupling capacities not less than the designated value from the layout data, extracts the coupling capacities of the nodes which are selected by a circuit designer who judges that the influence of the coupling capacity on the circuit operation should be considered, and holds the information of the extracted coupling capacities.

The crosstalk analyzing portion 105 conducts the simulation using the net list created by the net list creating portion 102, input pattern and information of the coupling capacities extracted by the coupling capacity extracting portion 104. The waveform display portion 106 displays the results of the simulation in a waveform and confirms an operation waveform thereof to thereby verify the crosstalk influence of the coupling capacities on the circuit operation.

In the crosstalk verifying device having the above conventional configuration, the crosstalk influence on the circuit operation is verified only with respect to the coupling capacities not less than the designated value and the coupling capacities of the nodes selected by the circuit designer. However, the coupling capacities which are considered to affect the circuit operation actually depend upon the circuit operation pattern, the ratio of the coupling capacity value with respect to the total capacity value of the nodes, and the like. Consequently, in the conventional configuration, there is a problem such that crosstalk verification cannot be conducted taking account of all the coupling capacities which should be actually considered.

Furthermore, there may be considered a method of conducting simulation by extracting the coupling capacities of all the nodes of an object circuit to be verified. However, there is a problem such that the method is not practical because it takes too long time to conduct the simulation at present and therefore the simulation is difficult to be conducted.

### SUMMARY OF THE INVENTION

The present invention has been developed to solve these problems inherent to the conventional crosstalk verification which is conducted only with respect to a part of nodes designated by a designer. Therefore, an essential object of the invention is to provide a crosstalk verifying device, allowing an efficient and highly precise crosstalk verification by appropriately and automatically selecting a coupling capacity whose crosstalk influence on a circuit operation should be considered from layout data with reference to a circuit operation pattern.

Another object of the present invention is to provide a crosstalk verifying device, allowing the crosstalk verification at a high speed in a larger scale circuit by efficiently reducing the number of coupling capacities which should be considered.

In order to attain the above objects, an aspect of the present invention provides a crosstalk verifying device for verifying a crosstalk influence of a coupling capacity parasitic in a circuit, which includes node and coupling capacity selecting means for automatically selecting nodes and coupling capacities each having a crosstalk influence on a circuit operation to be considered, from a net list and layout data obtained from a circuit diagram, based on an input circuit operation pattern. In this arrangement, the node and coupling capacity selecting means extracts nodes satisfying a predetermined node extraction condition, extracts coupling capacities satisfying a predetermined coupling capacity extraction condition, and determines and selects the nodes to be verified based on the extracted nodes and the extracted coupling capacities.

With the above configuration of the present invention, the nodes whose influence of the coupling capacity should be considered are not selected by a circuit designer as in the conventional art, but the nodes can be appropriately and automatically selected so that it becomes possible to efficiently conduct the crosstalk verification with a high preciseness.

Moreover, in the above configuration, the coupling capacity extraction condition may be such that a ratio of a coupling capacity value with respect to the total capacity value of each node is not less than a designated ratio.

Thus, the ratio of the coupling capacity which occupies the total capacity value of each node is considered with the above configuration, and the nodes whose influence of the coupling capacities should be considered can be selected. Accordingly, since the ratio of the coupling capacity occupying the total capacity is considered for each node, the number of the coupling capacities which should be considered can be efficiently reduced and time required for processing can be reduced. Thus, the verification of the crosstalk is made possible at a higher speed in a larger scale circuit.

In the present invention, the node and coupling capacity selection may include static crosstalk analysis for extracting the coupling capacities of all the nodes satisfying the predetermined extraction condition from the layout data, and conducting a static crosstalk analysis using the extracted coupling capacities and the net list.

With the above configuration, since the static crosstalk verification is conducted, it becomes possible to select the nodes whose coupling capacity should be considered at a higher precision.

### BRIEF DESCRIPTION OF THE DRAWINGS

These and other objects and features of the present invention will be readily understood from the following detailed description taken in conjunction with preferred embodiments thereof with reference to the accompanying drawings, in which like parts are designated by like reference numerals and in which:.

FIG. 1 is a block system diagram showing an entire configuration of a crosstalk verifying device according to a first embodiment of the invention;

FIG. 2 is a flowchart for explaining an operation of the crosstalk verifying device shown in FIG. 1;

FIG. 3 is a graph showing an input pattern for explaining an operation of extracting simultaneous change nodes of the crosstalk verifying device shown in FIG. 1;

FIGS. 4A, 4B and 4C are data format diagrams for explaining a node selection operation of the crosstalk verifying device shown in FIG. 1;

FIG. 5 is a block system diagram showing an entire configuration of a crosstalk verifying device according to another embodiment of the present invention;

FIG. 6 is a flowchart for explaining an operation of the crosstalk verifying device shown in FIG. 5;

FIG. 7A is a circuit diagram including a node for explaining a method of verifying static crosstalk of the crosstalk verifying device shown in FIG. 5, FIG. 7B is a diagram showing a result of the calculation of W/L value, and FIG. 7C is a diagram showing a result of the static crosstalk analysis;

FIGS. 8A, 8B and 8C are data format diagrams for explaining a node selection operation of the crosstalk verifying device shown in FIG. 5;

FIG. 9A is a circuit diagram including a node for explaining a method of verifying static crosstalk of the crosstalk verifying device according to still another embodiment of the present invention, FIG. 9B is a diagram showing a result of a time constant calculation thereof, and FIG. 9C is a diagram showing a result of the static crosstalk analysis thereof;

FIG. 10 is an inverter circuit diagram for explaining a method of explaining a method of calculating a time constant shown in FIG. 9B;

FIG. 11 is a graph for explaining a node extracting operation of a crosstalk verifying device according to still another embodiment of the present invention;

FIG. 12 is a block system diagram showing an entire configuration of a crosstalk verifying device according to still another embodiment of the present invention;

FIG. 13 is a flowchart for explaining an operation of a crosstalk verifying device according to still another embodiment of the present invention;

FIG. 14 is a flowchart for explaining an operation of a crosstalk verifying device according to still another embodiment of the present invention;

FIG. 15 is a block system diagram showing an entire configuration of a crosstalk verifying device according to still another embodiment of the present invention; and

FIG. 16 is a block system diagram showing an entire configuration of a conventional crosstalk verifying device.

### DETAILED DESCRIPTION OF THE PREFERRED EMBODIMENTS

In a preferred embodiment of the present invention, a crosstalk verifying device is adapted to detect a crosstalk position when a signal transition is simultaneously generated in adjacent wirings and a coupling capacity between the wirings satisfies a specified designation condition. Thus, more efficient and highly precise crosstalk verification is intended to be realized by conducting a dynamic simulation with use of the coupling capacity per se between the adjacent wirings.

Furthermore, in preferred embodiments of the present invention, when nodes having coupling capacities to be considered are selected, a standard value of the capacity is previously set as a reference, and a circuit operation is finally confirmed by conducting simulation. Furthermore, the simulation result of the circuit including the coupling capacities is displayed in a waveform. In this simulation operation, no processing is conducted for cutting out a circuit, and a highly precise crosstalk verification can be effected by using all the target circuits to be verified.

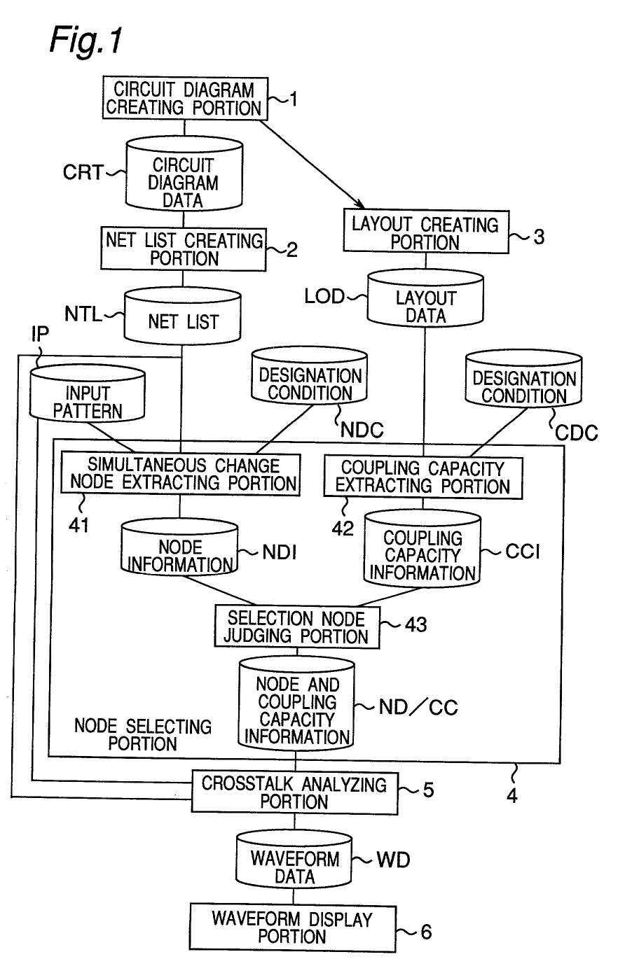

Hereinafter, preferred embodiments of the present invention will be explained with reference to FIGS. 1 to 15. Incidentally, elements common in each of the diagrams are denoted by the same reference numerals, and an overlapped explanation is omitted for the sake of convenience.

[First Embodiment]

FIG. 1 shows an entire configuration of a crosstalk verifying device of a first embodiment according to the present invention. In the first embodiment, as shown in FIG. 1, reference numeral 1 denotes a circuit diagram creating portion, reference numeral 2 denotes a net list creating portion, reference numeral 3 denotes a layout creating portion, reference numeral 4 denotes a node selecting portion, reference numeral 5 denotes a crosstalk analyzing portion, and reference numeral 6 denotes a waveform display portion. The circuit diagram creating portion 1 prepares a circuit diagram (CRT) by wiring and connecting circuit symbols for devices such as transistors, resistors, capacitors and the like. The net list creating portion 2 creates a net list (NTL) from the circuit diagram data (CRT) obtained from the circuit diagram creating portion 1. Meanwhile, the layout creating portion 3 prepares layout data (LOD) on the basis of the circuit diagram.

The node selecting portion 4 includes a node extracting portion 41, coupling capacity extracting portion 42 and selection node judging portion 43. The node extracting portion 41 extracts nodes satisfying a predetermined condition (NDC) from the net list (NTL) created by the net list creating portion 2 based on an input circuit operation pattern (IP). The coupling capacity extracting portion 42 extracts coupling capacities not less than a designated value from the layout data (LOD). The selection node judging portion 43 determines a node whose coupling capacity should be considered based on the extraction results of the node extracting portion 41 and the coupling capacity extracting portion 42. Thus, in the node selecting portion 4, a node having a crosstalk influence of the coupling capacity to be considered is selected.

In the first embodiment, the node extracting portion 41 is constituted as a simultaneous change node extracting portion 41 for extracting nodes simultaneously changing. The crosstalk analyzing portion 5 conducts simulation using the net list (NTL) created by the net list creating portion 2, the input pattern (IP), information of the nodes selected by the node selecting portion 4 and information of the coupling capacities (ND/CC), and generates waveform data (WD). The waveform display portion 6 displays the resultant waveform data obtained through the simulation.

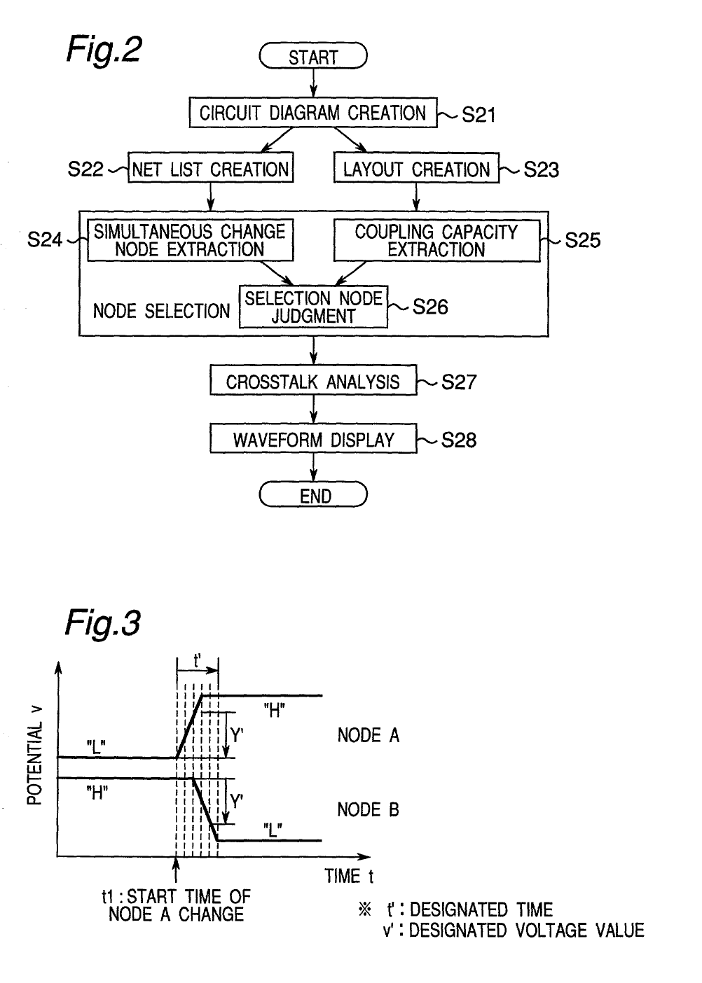

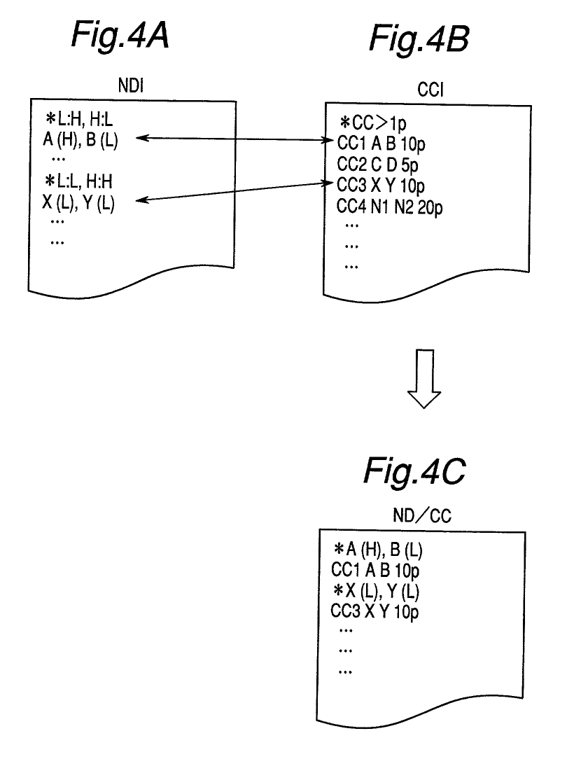

Next, an operation of the first embodiment will be explained by referring to FIGS. 1 to 4. FIG. 2 is a flowchart for explaining an operation of the first embodiment. FIG. 3 is a graph for explaining an operation of the simultaneous change node extraction portion 41. FIGS. 4A to 4C are explanatory diagrams showing a data format of node information (NDI) and the coupling capacity information (CCI) obtained in the node selecting portion 4. FIG. 4A shows simultaneously changing node information (NDI), FIG. 4B shows coupling capacity value information (CCI), and FIG. 4C shows the data of the node obtained in the selection node judging portion 43 and the data of the coupling capacity value information (ND/CC).

In the beginning of the operation, in step S21 of FIG. 2, the circuit diagram creating portion 1 prepares a circuit diagram. On the basis of the prepared circuit diagram, in step S23, the layout creating portion 3 prepares a layout. Meanwhile, in step S22, the net list creating portion 2 creates a net list (NTL) of a target circuit to be subject to a crosstalk analysis from the circuit diagram data (CRT). Next, in step S24, the simultaneous change node extracting portion 41 extracts simultaneously changing nodes from the net list (NTL) created by the net list creating portion 2 using the input pattern (IP). In this step, the simultaneous change of the nodes is regarded as the designation condition (NDC) for extracting nodes.

Specifically, as shown in FIG. 3, in the case where a node A changes from L level not less than a designated voltage value v′ to H level (or from H to L) with the input pattern (IP), and in the case where a node B changes from H level not less than the designated voltage value v′ to L level (or from L to H) within a designated time t′ from a time t₁ when the potential V on the node A begins to change, the simultaneous change node extracting portion 41 extracts the node A and node B regarded as simultaneously changing nodes to hold the extracted node information (NDI).

In step S25 in parallel to the processing in step S24, the coupling capacity extracting portion 42 extracts coupling capacities not less than the designated value (CC>1P) from the layout data with reference to the designation condition (CDC) for extracting the coupling capacities, and holds information of the extracted coupling capacities (CCI). In this step, a coupling capacity is not less than the designated value, it is regarded that the designation condition (CDC) for extraction of a coupling capacity is satisfied.

Next, in step S26, as shown in FIGS. 4A to 4C, when there is node information which agrees both with respect to the node information (NDI) extracted in step S24 and with respect to the coupling capacity value information (CCI) extracted in step S25, the selection node judgment portion 43 determines the node that the crosstalk influence of the coupling capacity of the node should be considered. These nodes and the coupling capacity value information (ND/CC) which are judged to be considered are held in the selection node judging portion 43 in a data format readable in the subsequent simulation processing. In FIGS. 4A to 4C, although the data format is shown by an output example in a SPICE format, the present invention is not limited thereto.

Next, in step S27, the crosstalk analyzing portion 5 conducts the simulation using the net list (NTL) created by the net list creating portion 2, the input pattern (IP), and information (ND/CC) of the nodes and the coupling capacities selected and held in the node selecting portion 4 to thereby generate waveform data (WD) as a result of the simulation. In step S28, the waveform display portion 6 displays the waveform data (WD) obtained as a result of the simulation.

As described above, whereas the nodes having influence of the coupling capacity to be considered is selected by a circuit designer in the prior art, according to the first embodiment of the present invention, since the nodes can be appropriately and automatically selected from the layout data based on the input circuit operation pattern, an efficient and more highly precise crosstalk can be conducted.

[Second Embodiment]

A basic configuration and an operation of a second embodiment are the same as the configuration and the operation of the above first embodiment shown in FIGS. 1 and 2. The second embodiment is different from the first embodiment in that the designation condition (CDC) of the coupling capacity extracting portion 42 in the node selecting portion 4 is modified as described below. That is, in the first embodiment, the coupling capacity not less than the designated value is extracted. On the other hand, in the second embodiment, in order to consider the ratio of the coupling capacity value with respect to the total capacity value of each of the nodes, a threshold value of the ratio of the coupling capacity to be extracted is previously established so that the coupling capacity not less than the designated ratio is extracted.

According to the second embodiment, since the ratio of the coupling capacity occupying the total capacity for each node is considered, the nodes whose influence of the coupling capacity should be considered can be selected more precisely than in the case of the first embodiment, so that the crosstalk verification can be effected more precisely.

[Third Embodiment]

A basic configuration and an operation of a third embodiment are the same as the configuration and the operation of the above first embodiment shown in FIGS. 1 and 2. The third embodiment is different from the first embodiment in that the designation condition (CDC) of the coupling capacity extracting portion 42 in the node selecting portion 4 is changed as described below. That is, in the first embodiment, the coupling capacity not less than the designated value is extracted. On the other hand, in the third embodiment, the characteristics of the first embodiment and the second embodiment described above are combined to extract a coupling capacity which is not less than the designated value and the ratio of the coupling capacity value with respect to the total capacity value of each node is not less than the designated ratio.

According to the third embodiment, since the ratio of the coupling capacity occupying the total capacity for each node is considered with respect to the coupling capacity which is not less than the designated value, the number of the coupling capacities to be considered can be efficiently reduced. As a consequence, time required for the processing step can be reduced and the crosstalk can be verified at a high speed in a larger scale circuit.

[Fourth Embodiment]

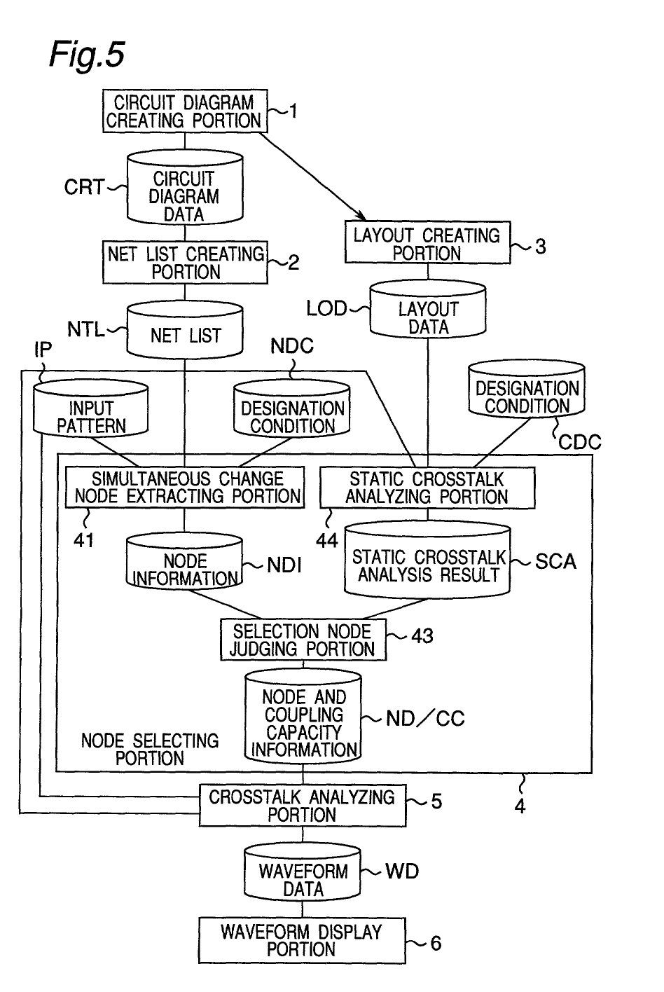

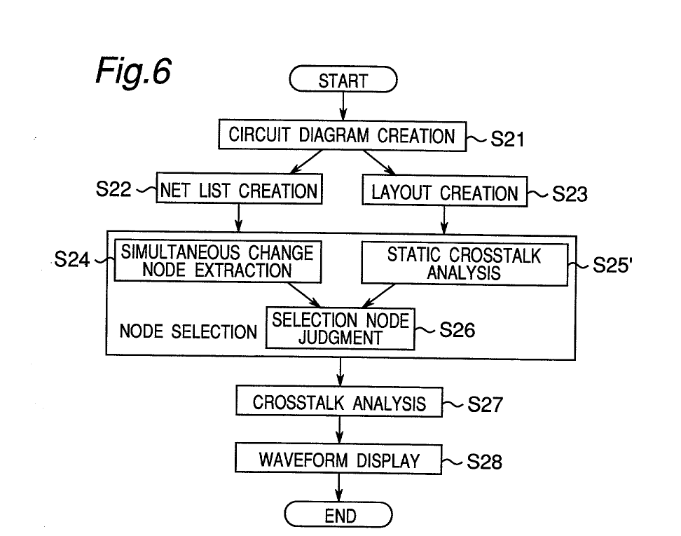

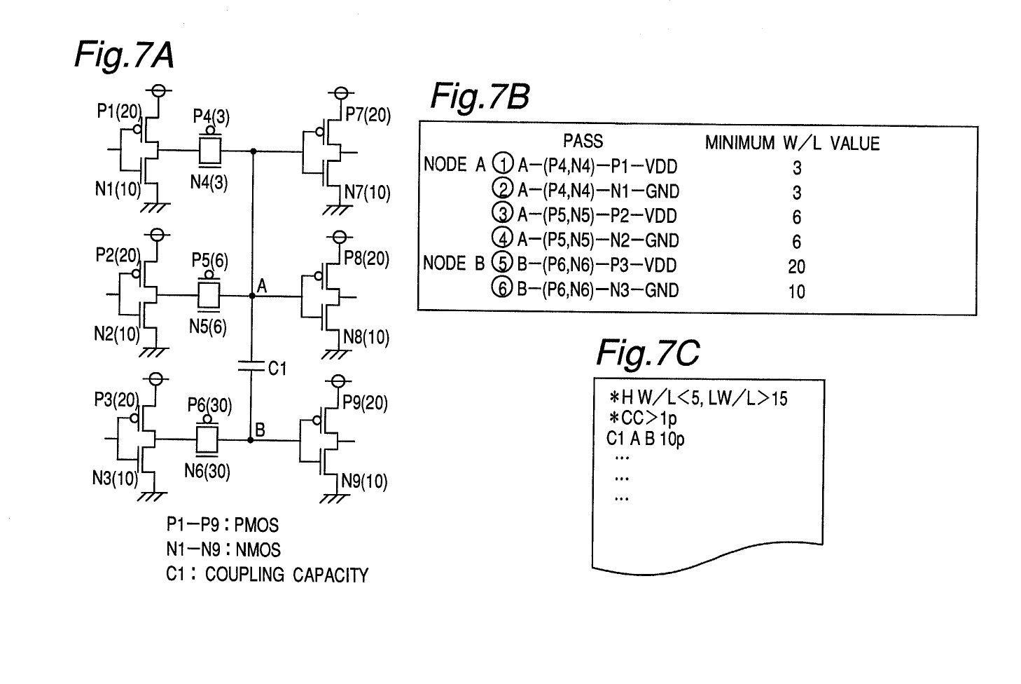

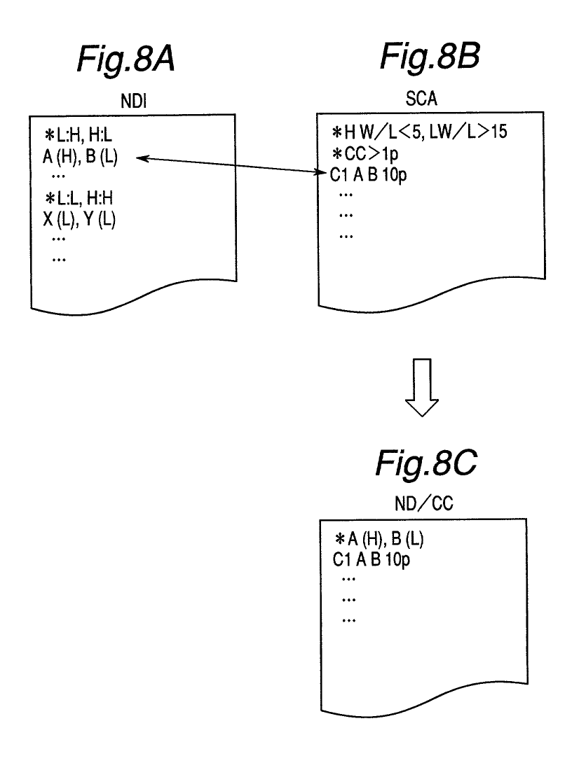

A fourth embodiment of the invention will be explained by referring to FIGS. 5 and 8. FIG. 5 shows an entire configuration of a crosstalk verifying device according to the fourth embodiment of the present invention. FIG. 6 is a flowchart for explaining an operation of the fourth embodiment of the present invention. FIGS. 7A to 7C are diagrams for explaining a method of verifying a static crosstalk. FIG. 8 shows an example of a data format of information of the node and coupling capacity obtained in the node selecting portion 4.

A basic configuration and an operation of the fourth embodiment are the same as those of the first embodiment shown in FIGS. 1 and 2. The fourth embodiment is different from the first embodiment in that, while the coupling capacity extracting portion 42 is provided in the node selecting portion 4 in the first embodiment, the configuration in the fourth embodiment is changed in a manner such that a static crosstalk analyzing portion 44 is provided for verifying the static crosstalk in the place of the coupling capacity extracting portion 42.

That is, in the fourth embodiment, in the same manner as the first embodiment, the node selecting portion 4 for selecting a node having an influence of the coupling capacity to be considered includes a simultaneous change node extracting portion 41 for extracting simultaneously changing nodes from the net list (NTL) created by the net list creating portion 2 based on the input pattern (IP). A specific feature of the fourth embodiment lies in the fact that the static crosstalk analyzing portion 44 is provided for extracting the coupling capacities of all the nodes from the layout data (LOD) and verifying the static crosstalk using the net list (NTL) created by the net list creating portion 2. Furthermore, it is so constituted that a selection node judging portion 43 is provided for determining the node to be considered based on the results of the simultaneous change node extracting portion 41 and the static crosstalk analyzing portion 44.

Next, an operation of the fourth embodiment will be explained by referring to FIGS. 5 to 8. In FIG. 6, since the processes in steps S21 to S24 are the same as those in the first embodiment, an explanation thereof will be omitted here. In step S25′, the static crosstalk analyzing portion 44 extracts the coupling capacities of all the nodes from the layout data (LOD) to conduct a static crosstalk verification using the information of the extracted coupling capacity and the net list (NTL) created by the net list creating portion 2.

A method of verifying a specific static crosstalk will be explained by an example shown in FIGS. 7A, 7B and 7C. In a transistor circuit to be verified which is shown in FIG. 7A, symbols P1 to P9 denote PMOS transistors, symbols N1 to N9 denote NMOS transistors, symbol C1 denotes a coupling capacity, and numbers in parentheses denote a gate width W and a gate length L is set to 1.

First, a coupling capacity not less than a designated value is retrieved. In the case where the coupling capacity C1 exceeds the designated value, all the passes are retrieved up to the power source node defined as a power source and the GND nodes from respective nodes A and B on both sides of C1. Then, the W/L values of transistors having a minimum W/L value are extracted out of the transistors driving the node A and the node B for each of these passes. The results of the extraction are shown in FIG. 7B.

Next, the transistors are classified into two group: a first group having a large driving force (with a low impedance) and a second group having a small driving force (with a high impedance) by referring to the designated W/L values. Thus, it is verified as to whether a pair of a high impedance transistor and a low impedance transistor is present with respect to the coupling capacity C1. In the case where W/L<5 is set to the designated reference value as a high impedance and W/L>15 is set to the reference value as a low impedance both with respect to PMOS and NMOS, pairs of (1) and (5), (2) and (5) shown in FIG. 7B are present as a pair which satisfy the designation condition. When the above pair is present, it is judged that C1 denotes a coupling capacity whose influence of the circuit operation should be considered. Then, the static crosstalk analyzing portion 44 holds information of the coupling capacity C1 together with the node information as a result of the static crosstalk analysis (SCA).

Next, in step S26, the selection node judging portion 43 judges that, when the node information (NDI) shown in FIG. 8A extracted in step S24 and the information of the static crosstalk analysis result (SCA) shown in FIG. 8B extracted in step S25′ agree with each other, the node is determined as a node having an influence of the coupling capacity to be considered. The selection node judging portion 43 holds the information (ND/CC) on the determined node and the coupling capacity value in a form readable by the simulator in the next processing step. Here, there is shown an output example in the SPICE forma, but the present invention is not limited thereto. Incidentally, the crosstalk analysis in step S27 and the waveform display in step S28 are the same as those of the first embodiment, and the explanation thereof is omitted here.

According to the fourth embodiment, since the static crosstalk verification is conducted, it becomes possible to highly precisely select the node whose coupling capacity should be considered, as compared to the case of the first embodiment.

[Fifth Embodiment]

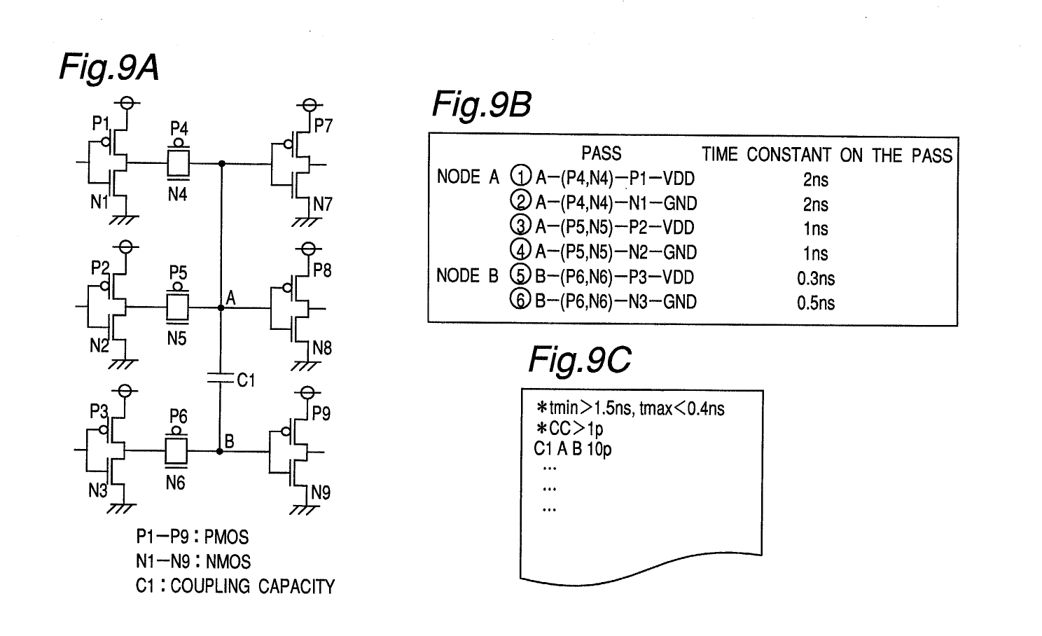

A fifth embodiment will be explained hereinbelow by referring to FIGS. 5, 6, 9 and 10. A basic configuration and an operation of the fifth embodiment are the same as those of the fourth embodiment shown in FIGS. 4, 5 and 6. The fifth embodiment is different from the fourth embodiment in configuration in the fact that the method of verifying the static crosstalk by the static crosstalk analyzing portion 44 in the node selecting portion 4 is verified using a time constant of the transistor in the fifth embodiment. That is, in the fourth embodiment, the minimum W/L value on the pass shown in FIGS. 7A, 7B and 7C is used, whereas in the fifth embodiment, the time constant on the pass is used as shown in FIGS. 9A, 9B and 9C. A circuit configuration including the node to be analyzed in FIG. 9A is the same as a configuration in which the gate width data W is eliminated from the circuit configuration of FIG. 7A of the fourth embodiment.

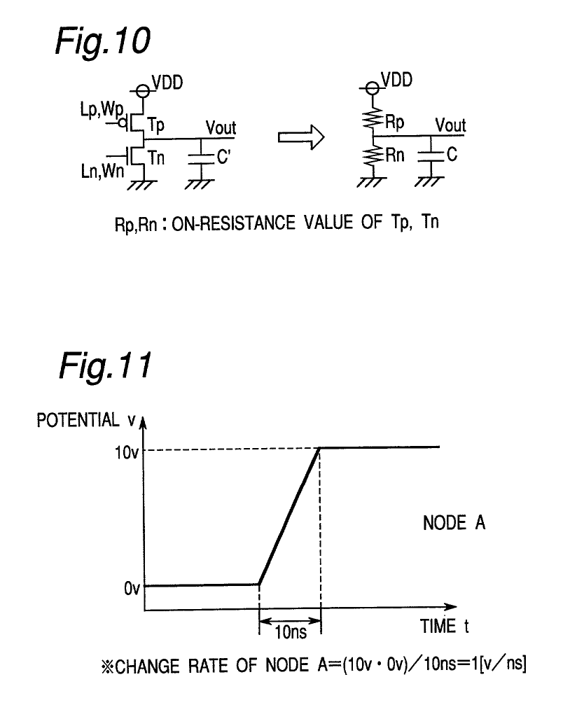

A specific static crosstalk verification method using the time constant will be explained by referring to FIGS. 9 and 10. In the beginning of the steps, a coupling capacity not less than a designated value is retrieved. In the case where C1 exceeds the designated value, all the passes up to the power source node defined as a power source and the GND node from respective nodes are retrieved so that the time constant is calculated for each of the passes.

A method of calculating the time constant will be explained by referring to an inverter circuit shown in FIG. 10. The time constant refers to a rising time or a falling time of the node, and the time constant is represented by a multiplication value of an on-resistance value Rp or Rn of a transistor Tp or Tn constituting the inverter circuit and a load capacity C of a node Vout. Here, the load capacity C is a value of a sum total of a drain capacity of the transistors Tp and Tn constituting the inverter circuit and a wiring capacity of the node Vout and an input gate capacity at the next stage. In this example shown in FIG. 10, the rising time is Rp·C[ns] and the falling time is Rn·C[ns] from the time constant=R·C. FIG. 9B shows an example of the calculation results (1) to (6) of the time constant.

Next, the transistors are divided into two group with reference to a threshold value of the designated time constant: a first group having a large driving force (with a low impedance) and a second group having a small driving force (with a high impedance). Then, it is verified as to whether a pair of a high impedance time constant and a low impedance time constant are present with respect to the coupling capacity C1. In the case where the high impedance time constant is tmin>1.5 ns and a low impedance time constant is tmax<0.4 ns, there are pairs of (1) and (5), (2) and (5) as a pair satisfying the designation condition shown in FIG. 9B. When the above pair is present, it is judged that C1 denotes a coupling capacity whose influence on the circuit operation should be considered. As shown in FIG. 9C, information of the coupling capacity is held together with the node information as a result of the static crosstalk analysis (SCA).

According to the fifth embodiment, since the verification of the static crosstalk is conducted using the time constant of the transistor, it becomes possible to more precisely select the node whose coupling capacity should be considered, as compared to the first embodiment.

[Sixth Embodiment]

A basic configuration and an operation of a sixth embodiment are the same as those of the fourth embodiment and fifth embodiment shown in FIGS. 5 and 6. The sixth embodiment is different from the fourth and fifth embodiments in that the designation condition in the static crosstalk verification conducted by the static crosstalk analyzing portion 44 in the node selecting portion 4 is changed as follows. That is, in the fourth and fifth embodiments, the coupling capacity not less than the designated value is retrieved. In the sixth embodiment, as explained in the second embodiment, the ratio of the coupling capacity value with respect to the whole capacity value of each node is considered, and there is set a threshold value of the ratio of the coupling value to be retrieved so that the coupling capacity not less than the designated ratio is retrieved. Then, in the sixth embodiment, the static crosstalk verification is conducted by combining the minimum W/L value on the pass explained in the fourth embodiment or the time constant of the transistor explained in the fifth embodiment.

According to the sixth embodiment, since the ratio of the coupling capacity which occupies the total capacity for each node is considered, it becomes possible to more precisely select the node whose influence of the coupling capacity should be considered so that more precise crosstalk verification is enabled as compared to the fourth and fifth embodiments.

[Seventh Embodiment]

A basic configuration and an operation of a seventh embodiment are the same as those of the fourth and fifth embodiments shown in FIGS. 5 and 6. The seventh embodiment is different from the fourth and fifth embodiments in that the condition in the static crosstalk verification conducted by the static crosstalk analyzing portion 44 in the node selecting portion 4 is changed as follows. That is, in the fourth and fifth embodiments, the coupling capacity not less than the designated value is retrieved. In contrast, according to the seventh embodiment, as explained in the third embodiment, the coupling capacity not less than the designated value and not less than the designated ratio designated with the ratio of the coupling capacity value with respect to the total capacity value of each node is retrieved. Then, in the seventh embodiment, the static verification is conducted by combining the minimum W/L value on the pass explained in the fourth embodiment or the time constant of the transistor explained in the fifth embodiment.

According to the seventh embodiment, since the ratio of the coupling capacity occupying the total capacity value for each node is further considered with respect to the coupling capacity which is not less than the designated value, the number of the coupling capacities to be subject to the static crosstalk verification can be efficiently decreased. As a consequence, the crosstalk verification can be conducted at a high speed in a larger scale circuit.

[Eighth Embodiment]

A basic configuration and an operation of an eighth embodiment are the same as those of the first to seventh embodiments. The eighth embodiment is different from the first to seventh embodiments in that the eighth embodiment is a modified example in which the designation condition (NDC) of the node extraction conducted by the node extraction portion 41 in the node selecting portion 4 is such that a node which changes at a rate not less than a designated change rate is extracted.

Here, the change rate refers to a voltage value which changes in the unit time. Specifically, as shown in FIG. 11, when the node A changes, for example, from 0 V to 10 V in potential in a time of 10 ns with the input pattern, the change rate of the node A is 1 V/ns. In the case where the designated change rate is 0.5 V/ns, the node A is extracted as a node which changes to not less than the designated change rate so that the information of the extracted node.

According to the eighth embodiment, since the designated change rate is used as the designation condition (NDC) for the node extraction, it is possible to conduct the crosstalk verification in consideration of the circuit operation in an analog manner.

[Ninth Embodiment]

A basic configuration and an operation of the ninth embodiment are the same as those of, for example, the first to seventh embodiments described above. The ninth embodiment is different from the first to seventh embodiments in that the ninth embodiment is a modified example in which the designation condition (NDC) for the node extraction conducted by the node extraction portion 41 in the node selecting portion 4 is such that nodes which change simultaneously and which change at a rate not less than the designated change rate are extracted. This is the same as the designation condition (NDC) for the node extraction which is the combination of the simultaneously changing nodes described in e.g. the first embodiment and the node extraction condition not less than the designated change rate explained in the eighth embodiment.

With the combination of the ninth embodiment, in any case of the first to eighth embodiments, more precise crosstalk verification is enabled.

[Tenth Embodiment]

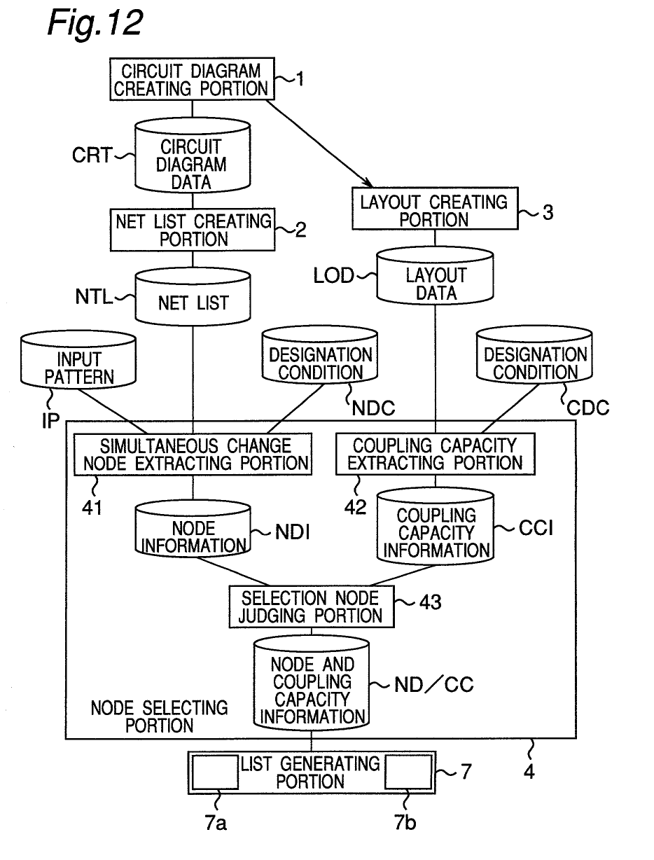

FIG. 12 shows an entire configuration of a tenth embodiment. A basic configuration and an operation thereof are the same as those of the node selecting portion 4 shown in FIG. 1 and the steps S21 to S26 shown in FIG. 2 of the above first embodiment. The tenth embodiment is different from the first embodiment in that, in the tenth embodiment the crosstalk analyzing portion 5 and the waveform display portion 6 are omitted, and a list generating portion 7 is provided for generating a list of information (ND/CC) on the node selected in the node selecting portion 4 and the coupling capacity value. The configuration with respect to the second to ninth embodiments can be also changed in a similar manner to that of this embodiment.

According to the tenth embodiment, since information of the coupling capacity whose influence on the circuit operation can be confirmed in a list form, more efficient circuit analyzing work can be effected.

[Eleventh Embodiment]

A basic configuration and an operation of an eleventh embodiment are the same as those of the tenth embodiment shown in FIG. 12. The eleventh embodiment is different from the tenth embodiment in that the eleventh embodiment is constituted so that the list generating portion 7 is provided with separate file portions 7a and 7b as shown in FIG. 12. That is, the generation files are classified into two groups: one group in which the delay of the selected node is fastened under the influence of the coupling capacity and the other group in which the delay of the node is slowed down under the influence of the coupling capacity.

More specifically, in the case where both of simultaneously changing nodes change in the same manner from H to L, or from L to H, the delay of the node having a weaker driving force becomes faster under the influence of the coupling capacity. On the contrary, in the case where one of the nodes changes from H to L and the other node changes from L to H in an opposite direction, the delay of the node having weaker driving force is slowed down under the influence of the coupling capacity. One group in which the delay of the node is fastened under the influence of the coupling capacity and the other group in which the delay of the node is slowed down under the influence of the coupling capacity are generated in a list form through the separated file portions 7a and 7b, respectively.

According to the eleventh embodiment, a change tendency of the circuit operation under the influence of the coupling capacity can be easily classified and more efficient circuit analyzing work can be realized as compared to the tenth embodiment.

[Twelfth Embodiment]

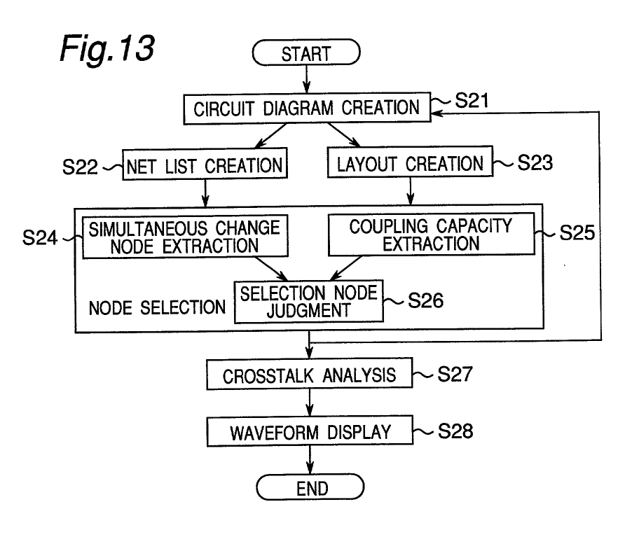

A basic configuration and an operation of a twelfth embodiment are the same as those of the first to eleventh embodiments. The twelfth embodiment is different from the first to eleventh embodiments in that the twelfth embodiment is constituted so as to have a function of returning the information of the node and the coupling capacity value (ND/CC) selected in the node selecting portion 4 to the circuit diagram creating portion 1. That is, as shown in FIG. 13, the judgment result of step S26 is returned to the circuit diagram creation step S21.

According to the twelfth embodiment, since the coupling capacity whose influence on the circuit operation should be considered is returned back to the circuit diagram, it becomes possible to continuously verify circuits more precisely thereafter.

[Thirteenth Embodiment]

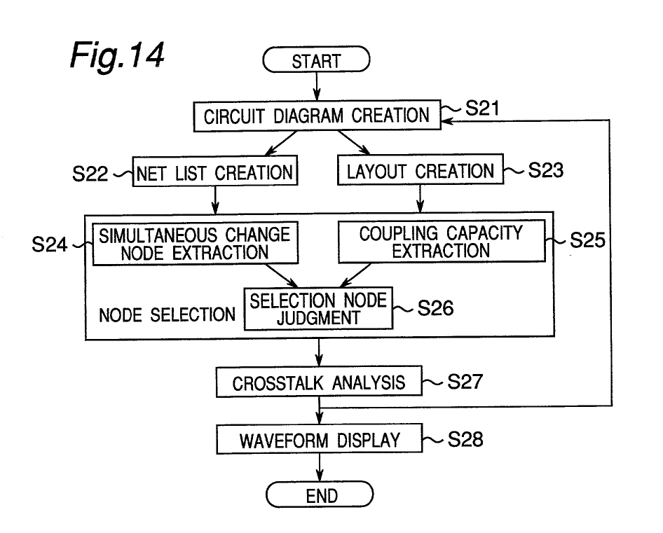

A basic configuration and an operation of a thirteenth embodiment are the same as those of the first to ninth embodiments. The thirteenth embodiment is different from the first to ninth embodiments in that the thirteenth embodiment is constituted to have a function of displaying the result of simulation executed in the crosstalk analyzing portion 5 in a highlight manner on the circuit diagram. That is, as shown in FIG. 14, the analysis result in step S27 is returned to the circuit diagram creation step S21.

According to the thirteenth embodiment, since the the simulation result after conducting the crosstalk analysis is displayed in a highlight manner on the circuit diagram, analysis of the result can be easily effected so that the efficiency of the circuit design can be improved.

[Fourteenth Embodiment]

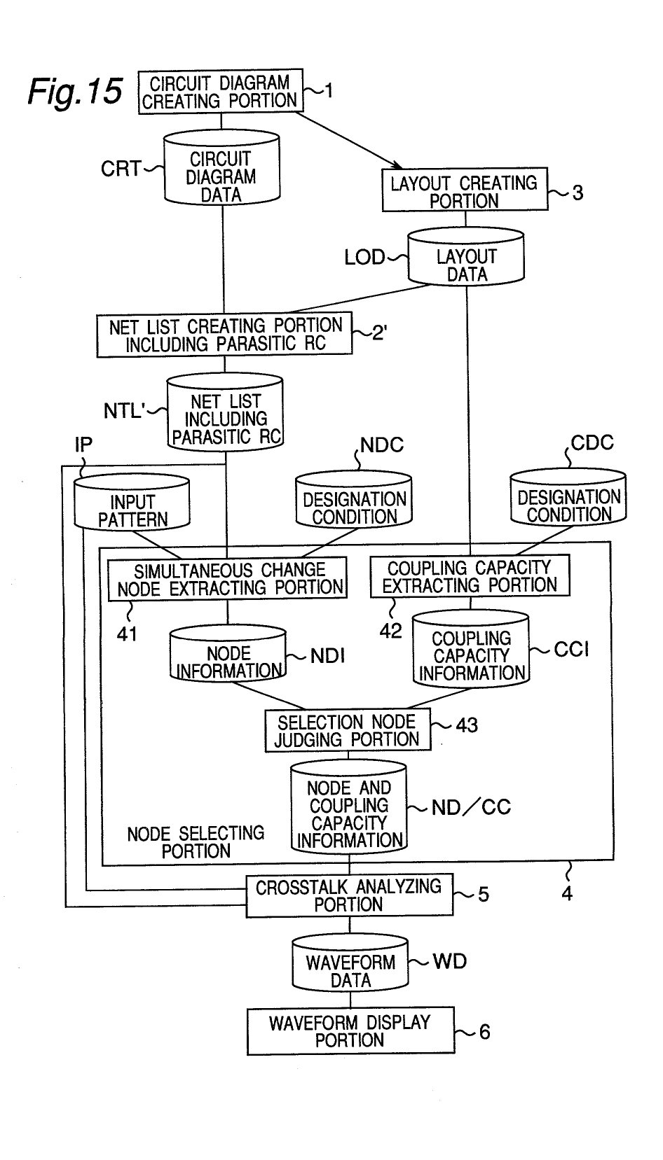

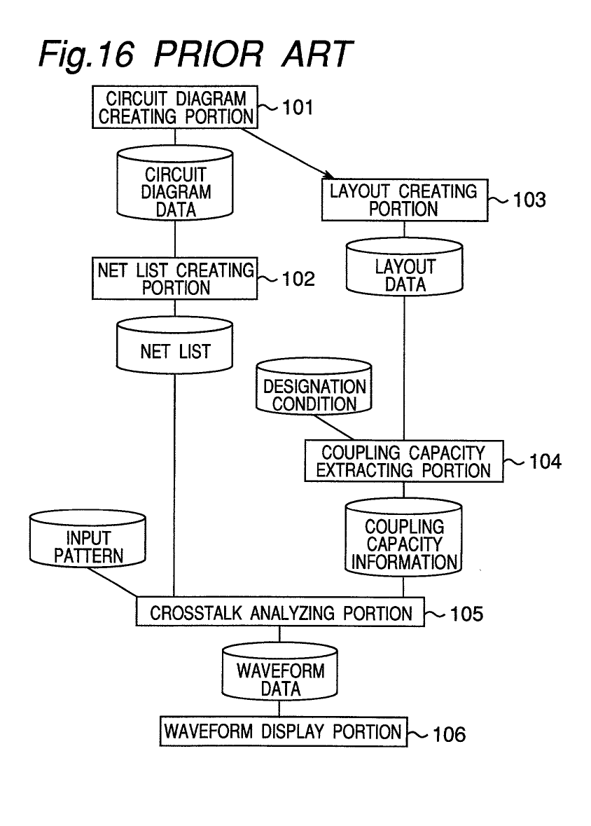

FIG. 15 shows an entire configuration of a fourteenth embodiment. A basic configuration and an operation thereof are the same as those of the first embodiment shown in FIG. 1 and FIG. 2. The fourteenth embodiment is different from the first embodiment in that, in the fourteenth embodiment, the net list creating portion 2′ is constituted to create a net list (NTL′) including a parasitic RC by extracting a parasitic resistance R and a parasitic capacity C of the wiring from the circuit diagram data (CRT) and the layout data (LOD). The configuration with respect to the second to thirteenth embodiments can be also changed to similar configurations.

According to the fourteenth embodiment, since the parasitic RC is used, a highly precise crosstalk verification is enabled close to an actual device.

As described above, according to the present invention, the coupling capacity whose influence on the circuit operation should be considered is appropriately and automatically selected based on the circuit operation pattern and the layout data so that an efficient and highly precise crosstalk verification is enabled. Further, the number of the coupling capacities to be considered can be efficiently reduced, as a consequence, the crosstalk can be verified at a high speed in a larger scale circuit. Consequently, the circuit characteristic and the quality of the semiconductor device can be improved.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A crosstalk verifying device for verifying a crosstalk influence of a coupling capacity parasitic in a circuit comprising:
node and coupling capacity selecting means for automatically selecting nodes and coupling capacities each having a crosstalk influence on a circuit operation to be considered, from a net list and layout data obtained from a circuit diagram, based on an input circuit operation pattern,
wherein the node and coupling capacity selecting means extracts nodes satisfying a predetermined node extraction condition, extracts coupling capacities satisfying a predetermined coupling capacity extraction condition, and determines and selects the nodes to be verified based on the extracted nodes and the extracted coupling capacities.

2. The crosstalk verifying device according to claim 1, wherein the node and coupling capacity selecting means comprises:
node extracting means for extracting the nodes satisfying the predetermined node extraction condition from the net list based on the input circuit operation pattern; and
coupling capacity extracting means for extracting the coupling capacities satisfying the predetermined coupling capacity extraction condition from the layout data,
wherein the node extracting means extracts the nodes each of which is simultaneously changing as satisfying the predetermined node extraction condition, and
the coupling capacity extracting means extracts the coupling capacities each of which is not less than a designated value as satisfying the predetermined coupling capacity extraction condition.

3. The crosstalk verifying device according to claim 2, wherein the node and coupling capacity selecting means further comprises selection node judging means for selecting and determining nodes whose coupling capacity should be considered based on the extraction results of the node extraction means and the coupling capacity extracting means, and creating and holding information of the selected nodes and the coupling capacities to be considered.

4. The crosstalk verifying device according to claim 1, further comprising means for conducting simulation of the nodes including the coupling capacities thereof selected by the node and coupling capacity selecting means, and means for displaying waveform data obtained as the result of the simulation.

5. The crosstalk verifying device according to claim 1, wherein the coupling capacity extraction condition is such that a ratio of a coupling capacity value with respect to the total capacity value of each node is not less than a designated ratio.

6. The crosstalk verifying device according to claim 1, wherein the coupling capacity extraction condition is such that a coupling capacity value is not less than a designated value and a ratio of a coupling capacity value with respect to the total capacity value of each node is not less than a designated ratio.

7. The crosstalk verifying device according to claim 1, wherein the node and coupling capacity selecting means comprises static crosstalk analyzing means for extracting the coupling capacities of all the nodes satisfying the predetermined extraction condition from the layout data, and conducting a static crosstalk analysis using the extracted coupling capacities and the net list.

8. The crosstalk verifying device according to claim 7, wherein the static crosstalk analyzing means extracts a coupling capacity not less than a designated value as the coupling capacity extraction condition.

9. The crosstalk verifying device according to claim 7, wherein the static crosstalk analyzing means extracts a coupling capacity when satisfying the coupling capacity extraction condition that a ratio of the coupling capacity value with respect to the total capacity value of each node is not less than the designated ratio.

10. The crosstalk verifying device according to claim 7, wherein the static crosstalk analyzing means extracts a coupling capacity not less than a designated value and having a ratio of the coupling capacity value with respect to the total capacity value of each node not less than a designated ratio, as the coupling capacity extraction condition.

11. The crosstalk verifying device according to claim 1, wherein the predetermined node extraction condition is such that a node is extracted which changes at a rate not less than a designated change rate.

12. The crosstalk verifying device according to claim 1, wherein the predetermined node extraction condition is such that the nodes are extracted which simultaneously change and which change at a rate not less than a designated change rate.

13. The crosstalk verifying device according to claim 1, further comprising list generating means for generating a list of the nodes and coupling capacities thereof selected by the node and coupling capacity selecting means.

14. The crosstalk verifying device according to claim 13, wherein the list generating means generates the list of the nodes and coupling capacities thereof by classifying the nodes and coupling capacities into two groups: one group in which a delay of each node is slowed down under the influence of the coupling capacity and the other group in which a delay of each node is fastened under the influence thereof.

15. The crosstalk verifying device according to claim 1, further comprising means for returning the coupling capacities of the nodes selected by the node and coupling capacity selecting means to the circuit diagram.

16. The crosstalk verifying device according to claim 1, further comprising means for displaying the execution result of the simulation on the circuit diagram in a highlight manner.

17. The crosstalk verifying device according claim 1, wherein the net list obtained from the circuit diagram is created as a net list including a parasitic resistance and a parasitic capacity of a wiring from the circuit diagram data and the layout data.
